(19) United States
(12) Patent Application Publication
(10) Pub. No.: US 2006/0290130 A1
(43) Pub. Date: Dec. 28, 2006

(54) Buckle with integrated belt tension sensor, and occupant restraint system using same

(75) Inventor: Christopher D. Hall, Algonac, MI (US)

Correspondence Address: FITCH EVEN TABIN AND FLANNERY, 120 SOUTH LA SALLE STREET, SUITE 1600, CHICAGO, IL, 60603-3406, US

(73) Assignee: Takata Seat Belts, Inc.

(21) Appl. No.: 11/166,795

(22) Filed: Jun. 24, 2005

(51) Int. Cl. B60R 22/00; A44B 11/25

(52) U.S. Cl. 280/801.1; 24/641

(57) ABSTRACT

A buckle and belt tension sensor are disclosed that optimize operation of the sensor without requiring significant modifications to the buckle and its operating mechanism. The sensor is mounted to a latch member having a body including tension responsive structure. The tension responsive structure can be at least one opening or gap in a sensor mounting portion of the body. In preferred forms, the tension responsive structure includes a split-body construction of the latch member body with the sensor mounted to extend between split portions thereof so as to enhance the capability of the sensor to detect tension in the seat belt. The split latch member body may be either of a single-piece or multiple-piece construction, although the multi-piece latch member is preferred for enhancing the response of the sensor to tension forces in the seat belt.

### FIELD OF THE INVENTION

The present invention pertains to a buckle used in a seat belt device provided for a seat of a vehicle, such as an automobile, and an occupant restraint system incorporating the buckle.

### BACKGROUND OF THE INVENTION

A conventional vehicle occupant weight sensing system senses the weight of the occupant and includes a weight sensor placed within the vehicle seat. Typically, the sensor is directly within the vertical load path of an occupant's weight and responds to the weight of the occupant on the seat.

A weight sensing system is typically used in conjunction with a control system for controlling the deployment of an occupant protection device. One example type of an occupant protection device that may be controlled responsive to sensed weight is an inflatable occupant restraint device that includes an air bag. Upon the occurrence of a condition, such as a collision or other accident, for which an occupant is to be protected, the restraint device is deployed and the air bag is inflated within an occupant compartment.

A seat belt is a common component used to secure an occupant on a vehicle seat. A buckle is usually provided for fastening and unfastening of the seat belt. A buckle generally includes a latch member provided with a projecting portion, which engages a tongue, wherein the latch member is biased by a spring in such a direction as to engage the tongue.

Generally, it is not desirable to deploy an airbag when the occupant is very small, such as with occupants in the lower 5 percentile range of weights for females which includes most children. Typically, the tension in the seat belt webbing secured about the occupant causes a downward force to be exerted upon the occupant. If sufficient, the magnitude of this downward force may be detectable by the weight sensor. As such, this downward force may affect the perceived weight of the occupant or object on the seat as sensed by the seat (weight) sensor. This false weight reading can be exacerbated where the child is in an auxiliary seat on the vehicle seat. In this instance, the seat belt tension possibly may put enough additional load on the seat sensor to make a child in an auxiliary seat appear to weigh as much as a 5% female or higher. In these circumstances, the on-board seat belt restraint system may undesirably deploy an air bag in the event of a collision or other accident.

In efforts to address this concern, passenger restraint systems have been proposed including a sensor for sensing downward force on a seat and a separate sensor for sensing tension in an associated seat belt. A controller is included for determining the actual weight of the seat occupant as a function of the outputs of the respective sensors. Ideally, by accurately gauging the seat belt webbing tension, the controller can correct and compensate for the induced error due to the belt webbing tension so as to ensure proper airbag deployment.

A seat belt tension sensor potentially could be packaged in a number of locations of the seat belt assembly. Current designs provide a separate assembly from the buckle to sense belt tension in a seat belt system. Incorporation of such a sensor in the buckle also generally has been proposed. However, in practice it is very problematic to deploy a reliable tension sensor in buckle itself, e.g., due to the small size requirements, packaging considerations, and additional wear and contamination considerations at the buckle, and also the need to limit the number of parts necessary to integrate such a sensor into the seat belt system from standpoints of cost and manufacturing ease.

To this end, U.S. Pat. Nos. 6,264,236 and 6,382,667 disclose mounting a strain gauge to a latch plate that is operable to releasably hold a tongue plate inserted in the buckle. However, there is no detailed consideration as to where the strain gauge sensor is to be positioned on the latch plate and/or the construction of the latch plate itself in terms of optimizing the response of the sensor to loading on the latch plate due to tension in the seat belt secured about the seat occupant.

Accordingly a need continues to exist for a reliable, low cost, simple, and robust seat belt tension sensor that can be used to input additional seat occupant information to an airbag controller to control airbag deployment. Further, a need exists for a buckle having a tension sensor that has an enhanced response to seat belt tension.

### SUMMARY OF THE INVENTION

In accordance with one aspect of the present invention, a buckle and belt tension sensor are provided that optimize operation of the sensor without requiring significant modifications to the buckle and its operating mechanisms, in particular with respect to the configuration and/or size thereof. For this purpose, the sensor is mounted to a latch member having tension responsive structure, preferably in the form of a split-body of the latch member so that the sensor extends between split portions thereof for enhancing the capability of the sensor to detect tension in the seat belt. The split latch member body may be either of a single-piece or multiple-piece construction, although the multi-piece latch member is preferred for enhancing the response of the sensor to tension forces in the seat belt. In either instance, however, the split-body, latch member construction does not affect size or operation of the buckle mechanism in any significant way.

On the other hand, as mentioned, the split body of the latch member does enhance the capacity for the sensor, preferably a strain gauge, to effectively detect tension in the seat belt with the tongue plate releasably latched in the buckle. More specifically, the preferred strain gauge measures deformation of the body of the latch member due to strain applied thereto by the seat belt tension. By having a split-body construction, the latch member body can transmit a greater amount of strain under loading to the sensor so that the sensitivity of the strain gauge need not be as great as otherwise might be required with latch members lacking a split-body construction, as described herein. The split body construction of the latch member allows the strain gauge to generate an output signal of a greater magnitude to improve on its measurement resolution since typically reliable strain measurements can be difficult due to the low level of output from these types of sensors.

In the preferred form, the split-body, latch member has a forward tongue engaging portion and a rear portion that are completely split from each other so that they are spaced to form a gap therebetween. The sensor is mounted to the latch member to extend longitudinally between the split portions to span the gap. When the tongue engaging portion of the latch member is in its locked position relative to the tongue plate with the seat belt secured about an occupant on the seat, the distinct latch member portions can shift relative to each other along the frame of the buckle due to the loading on the tongue engaging portion generated by the tension in the seat belt. With the preferred strain gauge sensor herein, small deformation of the latch member portions creates strain in the sensor that is measured as by a change in its electrical resistance to provide an indication of the tension in the seat belt. The relative movement between the completely split latch member portions will create even larger strains in the sensor over that provided by the otherwise small deformation thereof so that seat belt tension can be more easily determined.

It should be noted that there are current latch members having a unitary split body construction but with the forward and rear portions being interconnected by a longitudinally extending portion that is narrower than the wider, laterally extending forward and rear latch portions so that the latch member has a one-piece, generally H-shaped body. More specifically, the latch member has the H-shape provided at a rear section thereof. The latch member has a depending front portion or section from the H-shaped section of the body which engages in the window of the tongue plate for latching it in the buckle. The latch member having the completely split body construction so that there are distinct forward and rear portions or members described earlier is obtained by substantially eliminating the narrow portion of these current one-piece latch members. In this regard, the preferred form of the invention including a multi-piece latch member body and a strain gauge sensor that interconnects the distinct latch body members does not require changes to any of the other buckle components or otherwise affect operation of the buckle since the strain gauge sensor has a thin or low profile body and generally takes up the space between the latch body members formerly occupied by the narrow portion of the one-piece latch member body, and interconnects the body members.

In another form, it is also anticipated that the seat belt tension sensor can be effectively utilized with the current unitary split-body latch member so as to avoid changing the standard buckle configuration but for the integration of the sensor therewith. In this form, the preferred strain gauge sensor is mounted to extend along the narrow portion of the latch body and is fixed to the forward and rear wide or wing portions thereof. In this manner, the strain gauge sensor is on a section of the latch member body that will undergo greater longitudinal deformation when the seat belt is loaded which allows the sensor to generate a larger output signal for increased measurement resolution. In other words, since the loaded strain sensor extends primarily along the narrow portion of the latch body and is fixed to wide portions of the body at either end of the narrow portion, the loaded latch member will deform along the same portion of the latch member, i.e. the narrow portion, along which the strain sensor extends but to which it is not fixed.

In this form with the latch member having a unitary split body, the wide front and rear wing portions each include laterally extending tab portions that fit in respective openings in the buckle frame. The openings have forward or stop wall portions that limit forward shifting of the respective latch member front and rear portions when the latch member is loaded. Loading of the latch member occurs when the seat belt is secured about a seat occupant by releasably latching the seat belt tongue plate in the buckle. The tension this generates in the seat belt is transferred to a force on the tongue plate that pulls the latch member tab portions forwardly toward the adjacent forward stop wall portions of the frame openings.

Preferably, the relative sizing of the latch member and frame openings, and specifically the longitudinal spacing between tabs of the front and rear portions and the longitudinal spacing of the forward wall portions, respectively, is such that when the latch member is loaded the rear portion tabs will engage the adjacent forward wall portions when there is still spacing between the forward tabs and the forward wall portions adjacent thereto. In this regard, with the tongue plate latched in the buckle, the spacing between the rear set of tabs and adjacent forward wall portions is less than the spacing between the forward set of tabs and adjacent forward wall portions. This spacing allows the latch member to continue to deform when loaded after the rear tabs are engaged with the forward wall portions adjacent thereto. Thus, the spacing between the forward tabs and the stop or forward wall portions adjacent thereto may be taken up after the rear portion has engaged against the adjacent stop wall portions.

The spacing described above between tabs of the latch member and forward wall portions of the frame openings is also preferably provided with the previously described split latch member having distinct rear and forward portions that are interconnected by the sensor.

More specifically, in one preferred form where the buckle has a substantially conventional construction, the latch member body, which as mentioned may be single-piece or multiple-piece construction, is supported by side walls of a buckle frame to pivot between an unlatched position and a locked or latched position so that when a tongue plate is inserted to a predetermined position, the latch member pivots to the latched position to releasably hold the tongue in the buckle. A strain sensor is attached to the latch member so that it is operable to output signals to a controller corresponding to magnitude of strain sensed in the latch member when the tongue plate under seat belt tension is held in the latched or locked position by the latch member.

In one particular embodiment, the buckle includes a base having side walls, a latch assembly including a latch member supported by the side walls to pivot between an unlatched position and a latched position so that when a tongue plate is inserted to a predetermined position, the latch member pivots to the latched position to engage the tongue, and a strain sensor integrally attached to the latch member. The strain sensor is operable to output signals corresponding to magnitude of strain sensed in the latch member. An operating member releases the engagement between the tongue and the latch member. A lock member is mounted to the base to be movable between an unlocked position and a locked position with the lock member being set in the locked position to hold the latch member in the latched position when the tongue is engaged with the latch member, and being shifted by the operating member to the unlocked position to allow the locking engagement between the tongue and the latch member to be released.

In another particular embodiment, the latch member assembly of the buckle has a latch member constructed with a discrete first plate portion, a discrete second plate portion, and a connection integrally attaching the first and second plate portions wherein the connection incorporates the above-indicated strain sensor. In one embodiment, the strain sensor has a resistive strain sensor adapted to communicate with an occupant safety/seat belt system controller via conductive wiring. The conductive wiring may have a unitary wire harness having a contact portion operably attached between the strain sensor and the attached first and second plate portions of the latch member. In another embodiment, the strain sensor has first and second holes at opposite end portions thereof aligned with first and second apertures provided respectively in the first and second plate portions, and respective first and second attachment means interconnectedly extend therethrough for connecting these parts into a unitary assembly. The first and second attachment means may have, for example, rivets or other suitable mechanical attachment means.

In an alternative arrangement, the latch member assembly of the buckle has a latch member that is single-piece construction, and the strain sensor is operably attached to a surface thereof, such as via mechanical or adhesive means

Numerous advantages and benefits are provided by buckles of embodiments of the present invention. For instance, the need to provide a separate assembly to sense belt tension in a seat belt system is substantially eliminated. The compact design provided allows for a standard package size to be used without necessitating changes to accommodate the incorporation of the seat belt sensing equipment in the buckle. Cost savings are obtained as the strain sensor can be incorporated into the buckle with few parts being needed. Also, placement of the tension sensor in the buckle has advantages including locating the sensor close to the contact force of the tongue to latch with a consequent lowest possible system friction therebetween.

In another embodiment of the present invention, an occupant restraint system, which incorporates the aforesaid buckle, is provided for determining the weight of an object on an associated vehicle seat. The system has a sensor for sensing downward force on the associated seat; a seat belt assembly for restraining an object to the associated seat and sensing seat belt tension; and a controller. The seat belt assembly has a seat belt and a buckle operable for fastening/unfastening the seat belt. The buckle includes a base having side walls; a latch member assembly having a latch member supported by the side walls to pivot between an unlatched position and a latched position so that when a tongue is inserted to a predetermined position, the latch member pivots to the latched position to engage the tongue, and a strain sensor integrally attached to a surface of the latch member, said strain sensor operable to output signals corresponding to magnitude of strain sensed in said latch member, wherein said magnitude of strain is correlated to the amount of tension in the seat belt; an operating or operational member for releasing the engagement between the tongue and the latch member; and a lock member attached to the base to be movable between an unlocked position and a locked position, said lock member being set in the locked position to hold the latch member in the latched position when the tongue is engaged with the latch member, and being moved by the operational member to the unlocked position to allow the engagement between the tongue and the latch member to be released. The controller is operable to determine the weight of the object resting on the seat as a function of the sensed force and the sensed strain. The controller is operable to correlate the magnitude of strain sensed in the buckle to the amount of tension in the seat belt. The controller is operable to adjust a value functionally related to the sensed downward force with reference to a value functionally related to the sensed strain at the buckle to determine the weight of the object resting on the seat. In one embodiment, the controller is operable to subtract a value functionally related to the sensed strain from a value functionally related to the sensed downward force to determine the weight of the object. Accordingly, the controller is operable to process the sensory inputs acquired from the seat sensor and the strain sensor in the buckle to accurately calculate the weight of the occupant, classify the occupant, and thusly ensure that related safety components, such as airbags, are properly controlled with respect to the given seat in the event of an accident.

More generally, the latch member has tension responsive structure, that may include an opening or gap or gaps in the body thereof. The gap or gaps in the latch member body are in a sensor mounting portion thereof and create a greater response in the sensor mounting portion to tension applied thereto. Preferably, the sensor is mounted to the sensor mounting portion so that the sensor spans the opening or gap or has the openings or gaps closely adjacent thereto such as on either side thereof. Accordingly, for the previously described latch member, split-body construction, there is a single gap that extends for the entire lateral extent between the rear and forward latch member portions where these portions are distinct members and the sensor spans the gap to interconnect the body members, and there are laterally spaced gaps between the tabs of the forward and rear wing portions where the latch member body has a one-piece, H-shaped rear section including a narrow portion along which the sensor extends.

In addition to the above-described tension responsive structures for the latch member, the sensor mounting portion can include a bend portion so that there is a recess in the sensor mounting portion of the latch member. Accordingly, in this version there is a recessed gap formed in the sensor mounting portion of the latch member. The sensor is fixed on either side of the laterally extending recessed gap so as to span the gap. When tension is applied to the latch member, the bent portion will deform from an arcuate configuration toward a flat or straight configuration. In this manner, the sensor will be subject to greater strain than if there were no gap in the sensor mounting portion of the latch member.

It is also contemplated that rather than gaps, the openings can be smaller apertures or recesses in the sensor mounting portion of the latch member body. The sensor can be mounted to extend over the apertures or recesses, or alternatively to extend adjacent thereto. The small apertures or recesses like the gap openings create tension responsive structure in the sensor mounting portion so that it has enhanced response to tension applied thereto.

### BRIEF DESCRIPTION OF THE DRAWINGS

FIG. 1 is a perspective view of a buckle of the present invention.

FIG. 2 is a partial exploded perspective view of the buckle of this embodiment showing a latch mechanism including an integrated belt tension sensor.

FIG. 3 is an exploded perspective view similar to FIG. 2 showing the sensor and distinct portions of a split latch member of a latch member assembly of the latch mechanism disassembled.

FIG. 4 is a side sectional view showing the buckle of this embodiment in an unlatched state in which a tongue plate is not releasably locked in the buckle.

FIG. 5 is a side sectional view showing the buckle of this embodiment in a latched state in which the tongue is releasably locked in the buckle.

FIG. 6 is a schematic view showing a guide openings formed in a sidewall of a base frame of the buckle for receiving associated operating components of the buckle.

FIG. 7 is an enlarged, plan view of the buckle of this embodiment taken along line 7-7 in FIG. 1 showing the sensor interconnecting the distinct rear and forward portions of the latch member.

FIG. 8 is an exploded, perspective view of the latch member assembly of the buckle of FIG. 7.

FIG. 9 is another partial plan view showing the latched state in which the tongue plate connected to a seat belt under tension is releasably locked in the buckle.

FIG. 10 is a partial plan view of the latched state in which the tongue under belt tension is releasably locked in the buckle via the split latch member.

FIG. 11 is a sectional view taken along line 11-11 in FIG. 9 of the latched state in which the tongue under belt tension is releasably locked in the buckle.

FIG. 12 is a partial plan view of a buckle of an alternative embodiment of the present invention showing the sensor fixed on a unitary, split latch member.

FIG. 13 is an exploded, perspective view of a split latch member assembly of the buckle of FIG. 12 showing rear and forward wing portions of the latch member interconnected by a narrow, bridge portion.

FIG. 14 is a plan view showing the sensor fixed to extend along the narrow bridge portion of the latch member.

FIG. 15 is a perspective view of the latched state in which the tongue plate under belt tension is releasably locked in the buckle via the split latch member.

FIG. 16 is a side sectional view taken along line 16-16 in FIG. 14 of the latched state in which the tongue plate under belt tension is held within the buckle.

FIG. 17 is an enlarged side sectional view of a portion of a latch member assembly of an alternative embodiment of the present invention showing the sensor positioned across a recessed gap in the body of the latch member.

FIG. 18 is a schematic view of a seat belt assembly incorporating a buckle of FIG. 1 in accordance with an embodiment of the invention.

FIG. 19 is a schematic view of an occupant restraint system that incorporates the seat belt assembly of FIG. 18.

The figures are not necessarily drawn to scale. Similarly numbered elements in different figures represent like features unless indicated otherwise.

### DETAILED DESCRIPTION OF THE PREFERRED EMBODIMENTS

Hereinafter, embodiments of the present invention will be described with reference to the accompanying drawings. However, it is to be appreciated that the present invention is not limited to buckles used with an occupant restraint system. It is to be noted that the terms “right” and “left” used in the following description represent the right and the left in the drawings.

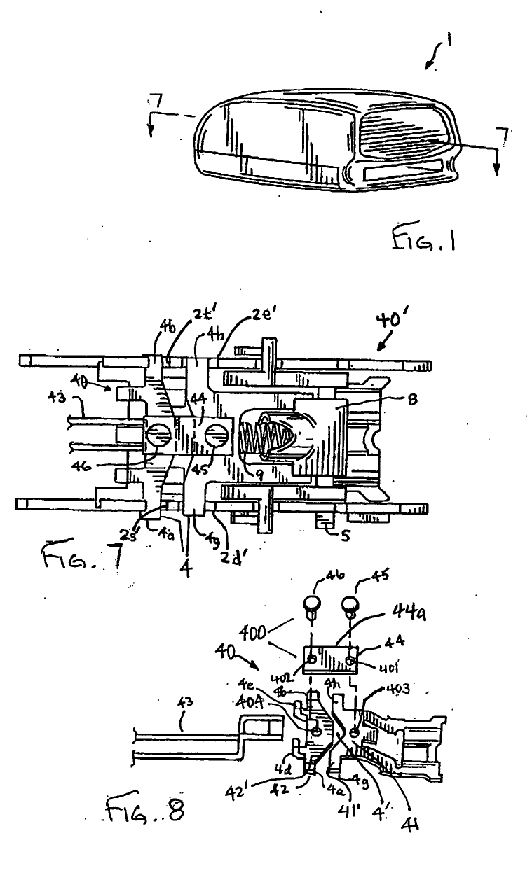

FIG. 1 illustrates a buckle 1 in assembled form according to one embodiment of the present invention. The various views of FIGS. 3 through 11 illustrate a number of components and related functionalities incorporated into the buckle 1, which will be discussed in detail below. The latch assembly 40 illustrated therein is especially significant to embodiments of the present invention. The latch member assembly 40 is an electromechanical component which multi-tasks as a mechanical component supporting tongue plate fastening/unfastening at the buckle and also incorporates a tension or strain sensor used to determine seat belt tension.

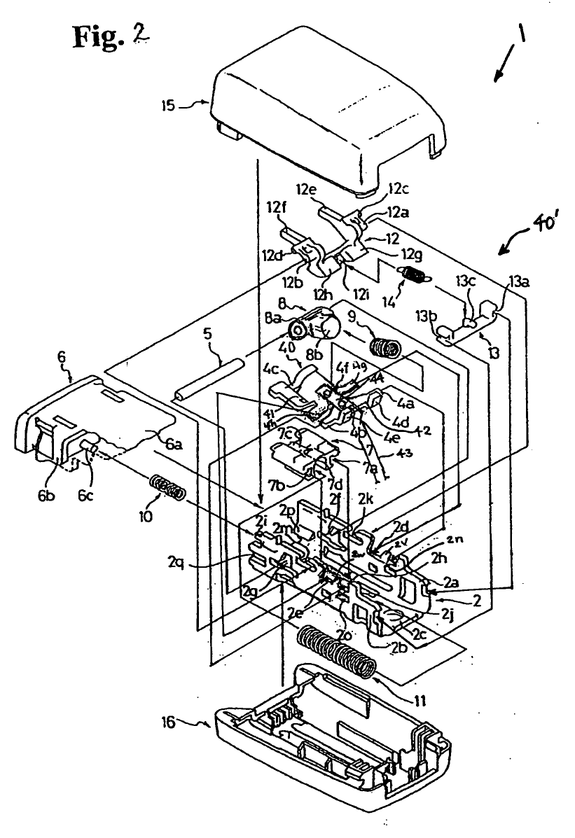

Referring to FIGS. 2, 3, 7-11, in one preferred embodiment the latch member assembly 40 includes tension responsive structure in the form of a multi-piece split-body of the latch member 4. The latch member 4 is part of the buckle operating or latch mechanism 40′ and operable to releasably lock a tongue plate 3 in the buckle 1 when inserted to a predetermined latched position therein. The preferred latch member has a body 407 including a forward tongue-engaging portion or member 41 and an adjacent, rear portion or member 42 that are completely split from each other so that they are spaced to form a gap 4′ therebetween. As the latch body members 41 and 42 are completely split, the gap 4′ extends all the way across the entire lateral extent of the latch members 41 and 42 so that they are completely spaced from each other in the longitudinal direction. A tension or strain sensor 44 is mounted to the latch member 4 to extend longitudinally between the split-apart portions 41, 42 to span the gap 4′. In this manner, the latch member body 407 has a sensor mounting portion including opening or gap 4′ that underlies the sensor 44 so that the sensor mounting portion is more responsive to tension applied thereto than if gap 4′ were not present.

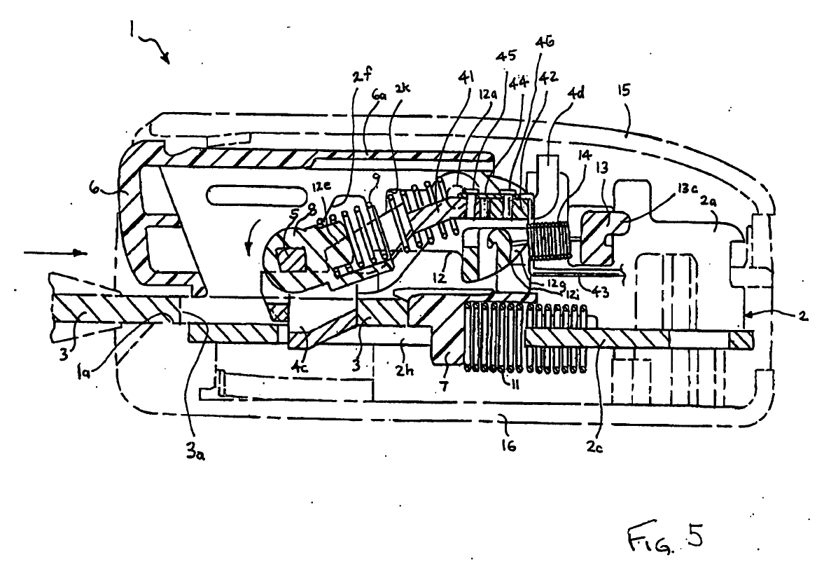

The separate latch member portions 41 and 42 are integrally joined by an interconnection 400 including the strain sensor 44 spanning and anchoring portions 41 and 42 together (e.g., FIGS. 3, 7-10). The strain sensor 44 can have a thin film body 44a having a small, rectangular strip shape configuration including first and second holes 401 and 402 at opposite end portions 401′, 402′ thereof. The holes 401 and 402 are aligned with first and second apertures 403 and 404 provided respectively in the first and second latch body portions 41, 42, and respective first and second attachment means 45 and 46 interconnectedly extend therethrough for connecting these parts into a unitary latching and sensing assembly (see FIG. 8). The first and second attachment means 45 and 46 may be, for example, rivets, threaded bolts which are collared on free ends below latch member 4, or other suitable mechanical fastening or attachment means (FIGS. 2-3, 7, 8, and 11). Alternatively, the strain sensor 44 may be adhesively fixed to portions 41 and 42, such as via a curable adhesive, such as an epoxy or other durable high tack resin. The sensor is preferably a strain gauge 44 that has a known construction. For instance, the body 44a of strain gauge 44 can include a metallic foil arranged in a grid pattern so as to be subject to strain in the longitudinal direction. The grid is bonded to a thin carrier as is known. Although the illustrations herein refer to a strain gauge as the sensor element, it will be appreciated that other types of sensors also may be used in the practice of the present invention, such as, e.g., piezoresistors sensors, Hall effect sensors, and so forth.

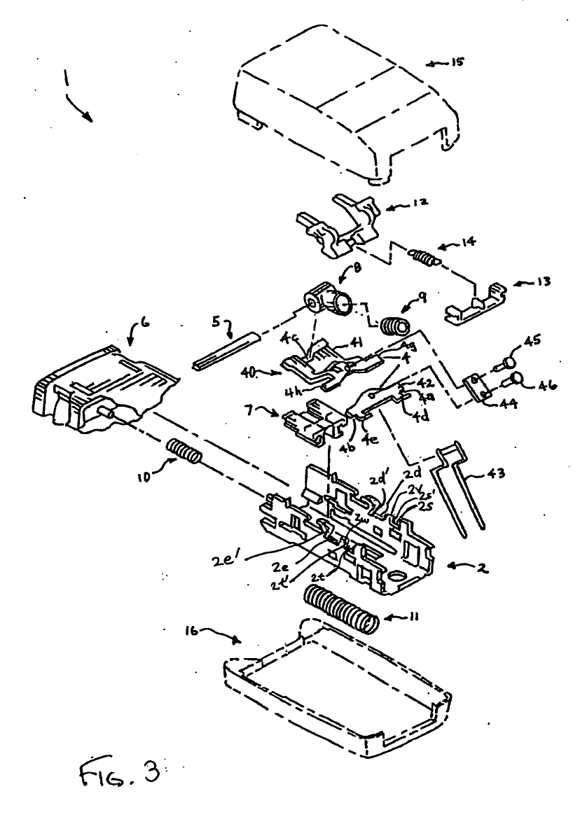

From a mechanical operational standpoint, the latch member 4 is operable to engage and hold the tongue plate (“tongue”) 3 of a seat belt system in the normal use of a seat belt 111 (FIGS. 4-5, 10). The larger, forward latch portion 41 of the latch member 4 engages and holds the tongue 3 when in a locked position. The tongue 3 is freely inserted into a forward, slot opening 31 of the buckle 1 until it engages an ejector 7 of the latch mechanism 40′ that is pushed rearward to cause the spring-loaded latch member 4 to shift down to latch into the window opening 30 of the tongue 3. Once the tongue 3 is latched in the buckle 1, it is substantially fixed therein. To release the tongue 3, an actuator in the form of a buckle press button 6 is depressed which lifts the second latch portion 42 out of the tongue window opening 3a allowing the ejector 7 to shift the tongue 3 out of the buckle housing 15, 16. Springs are associated with the press button, ejector, and latch member. The latch member body portion 42 includes side tabs 4a and 4b that are respectively positioned in openings or recesses 2d and 2e, respectively, of buckle base frame 2. (FIG. 2, 6). Similarly, latch member body portion 41 includes side tabs 4g and 4h that are respectively positioned in openings or recesses 2s and 2t, respectively, of base frame 2 of the buckle body (FIG. 2). These tabs of the latch member 4 are positioned within the respective recesses of the body of the buckle so that the latch member 4 will engage the base frame 2 of the buckle 1 when under extreme tension loading such as during a collision or other accident.

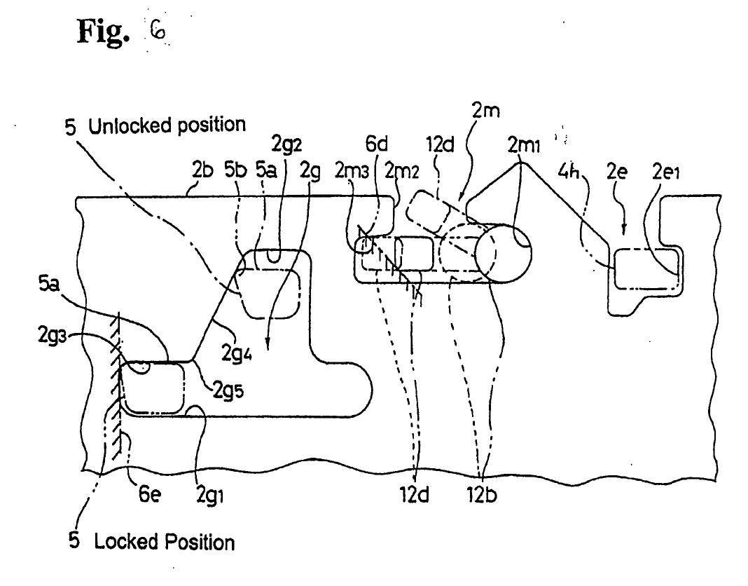

Referring to FIGS. 9 and 11, from a tension force sensing standpoint, when a tension force, indicated by force arrow F1, is applied to a seat belt 111, and, thus also upon the tongue 3 connected thereto, the tongue 3 pulls on the latch member 4 of the latch assembly 40, such as indicated by a corresponding elongation force indicated by force arrow F2. A slight displacement of first plate portion 41 occurs due to the belt tension, such as indicated by the movement of trailing edge 800 of the forward portion 41 from position 80 to a different slightly forwardly displaced position at 81 (FIG. 9). The strain sensor 44 senses the tension force F2 induced between the two latch member portions 41 and 42 when the tongue plate 3 is engaged by the latch member 4 in a latched position therebetween (FIG. 10). The strain sensor 44 thus is a sensor that detects strains in the material of the latch member 4. With a preferred strain gauge sensor herein, small deformation of the latch member portions 41, 42 creates strain in the sensor 44 that is measured as by a change in its electrical resistance to provide an indication of the tension in a seat belt restraining a passenger/child seat, which is connected to the latch member 4 via tongue plate 3. The relative movement between the completely split latch member portions 41, 42 will create even larger strains in the sensor 44 over that provided by the otherwise small deformation thereof so that seat belt tension can be more easily determined.

Input and output conductor members generally may be provided through which current travels to and from the strain sensor 44 to provide information to a controller which uses it to determine whether an airbag or other passenger protection device should be deployed. For example, a wire harness 43 may be used in this regard having a contact portion operably attached between the strain sensor 44 and the attached first and second latch portions 41 and 42 of the latch member 4. The operation of the strain sensor 44 is further discussed below in connection with FIG. 19.

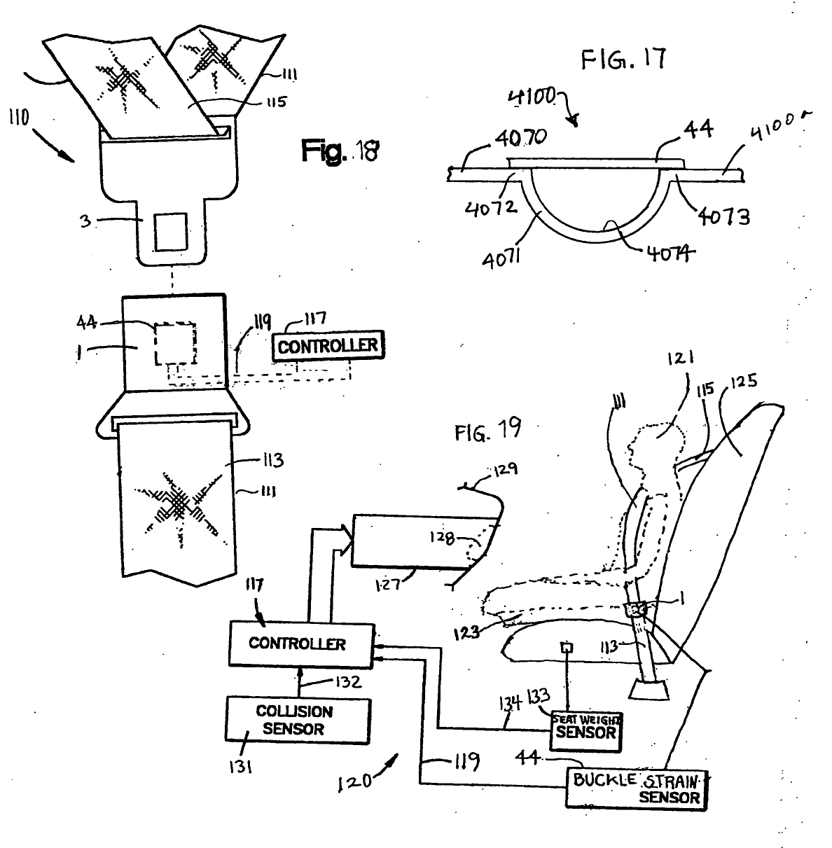

The manner by which latch member assembly 40 is utilized as a sensing device is described in more detail below with reference to FIGS. 18 and 19, which illustrate a seat belt assembly and related belt restraint system incorporating the buckle 1 and latch member assembly 40 thereof. Initially, however, the manner by which the latch member assembly 40 mechanically cooperates and functions in the fully assembled buckle 1 is described in the following further discussions of FIGS. 2-6. These descriptions are equally applicable to the alternative configuration of latch member assembly 405, described later herein.

As shown in FIGS. 2 through FIG. 6, the buckle 1 of this embodiment has a base 2 which is a generally U-shaped frame having longitudinally extending side walls 2a, 2b upstanding from either side of bottom wall 2c and the buckle operating mechanism includes; a latch member assembly 40 having a latch member 4 which is pivotally supported by the side walls 2a, 2b of the base 2 and can engage and hold a tongue 3 in the buckle; a lock pin 5 for preventing the latch member 4 from moving in the unlatching direction when the tongue 3 is engaged and held by the latch member 4; an operational button 6 disposed to the side walls 2a, 2b of the base 2 in such a manner that the operational button 6 can move in the longitudinal direction of the base 2; an ejector 7 disposed on the bottom 2c of the base 2 in such a manner that the ejector 7 can slide in the longitudinal direction of the base 2 and can urge the tongue in such a direction as to release from the buckle 1; a slider 8 having a lock-pin holding portion 8a for holding the lock pin 5; a slider spring 9 which is compressed and disposed between the slider 8 and the latch member 4 and always urges the slider 8 to press the lock pin 5 toward the latch member 4; a button spring 10 always urging the operational button 6; an ejector spring 11 always urging the ejector 7; an inertia lever member 12, i.e. movement preventing means, which is pivotally supported by the side walls 2a, 2b of the base 2 in such a manner that it can move in the longitudinal direction of the base 2 and which prevents the lock pin 5 from moving due to inertia to a release position where the engagement between the tongue 3 and the latch member 4 is released; a spring holder 13 supported by and fixed to the side walls 2a, 2b of the base 2; a lever spring 14 which is stretched and disposed between the inertia lever member 12 and the spring holder 13; and an upper cover 15 and a lower cover 16 engaging each other in such a manner that the base 2 on which the aforementioned components are assembled is covered from the top and the bottom.

The side walls 2a, 2b of the base 2 are provided with supporting openings or grooves 2d, 2e and supporting openings or grooves 2s, 2t, which are separated by intervening stops 2v, 2w (e.g., see FIG. 3). Grooves 2d, 2e are used for supporting tab portions 4g, 4h of the latch member 4. Grooves 2s, 2t are used for supporting tab portions 4a, 4b of the latch member 4. Inverted T-shaped guide holes 2f, 2g are used for supporting and guiding both end portions of the lock pin 5. A spring supporting portion 2i formed in one side wall 2b supports one end of the button spring 10. Guide grooves 2k, 2m support shaft portions 12a, 12b of the inertia lever member 12 in such a manner that the inertia lever member 12 can pivot and move in the longitudinal direction and which receive pressed portions 12c, 12d for returning the inertia lever member 12 from its operative position to its inoperative position by pressing the operational button 6. Receiving portions 2n, 2o have mounting portions 13a, 13b of the spring holder 13 fitted therein in such a manner as to allow the removal of the spring holder 13. Guide portions 2p, 2q are used for guiding the tongue 3 during the insertion of the tongue 3 into the buckle 1. In addition, the bottom 2c of the base 2 is provided with guide rail 2h (another one is disposed symmetrically with the guide rail 2h relative to the longitudinal to axis, but not shown), in which guide grooves 7a, 7b of the ejector 7 are slidably fitted and which guide the elector 7 in the longitudinal direction, and a spring supporting portion 2j for supporting one end of the ejector spring 11.

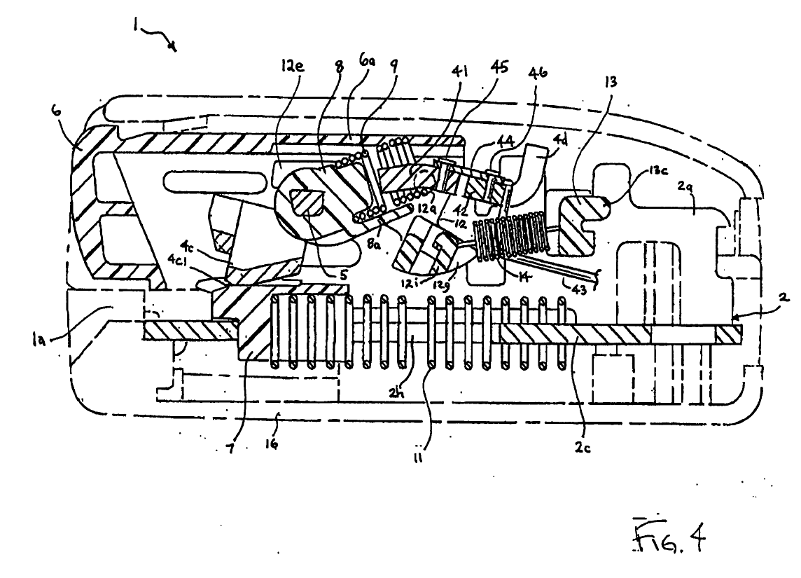

The configurations of the supporting groove 2e, the inverted T-shaped guide hole 2g, and the guide groove 2m formed in the side wall 2b are shown in FIG. 6. The supporting groove 2e has a supporting portion 2e1 for pivotally supporting the tab portion 4h of the latch member 4. The inverted T-shaped guide hole 2g has a longitudinal hole portion 2g1 extending in the longitudinal direction and a vertical hole portion 2g2 extending upwardly from a middle portion of the longitudinal hole portion 2g1. An upper portion of a left end of the longitudinal hole portion 2g a lock-pin holding portion 2g3 for holding the upper side of the lock pin 5 to prevent the upward movement of the lock pin 5 when the lock pin 5 is in its locked position (shown by a two-dot chain line in FIG. 6). A left end edge of the vertical hole portion 2g2 is a guiding portion 2g4 for guiding the lock pin 5 when the lock pin 5 moves from the unlocked position (shown by a chain line in FIG. 6) to the locked position or moves vice versa. The guiding portion 2g4 is an inclined surface extending upwardly in the right direction from the longitudinal hole portion 2g1. The intersection between the lock-pin holding portion 2g3 and guiding portion 2g4 is a rounded portion 2g5 formed in an arc shape, the radius of which is set preferably as small as possible.

The guide groove 2m has a shaft supporting portion 2m1 for supporting the shaft portions 12b of the inertia lever member 12, an opening 2m2 through which the pressed portion 12d of the inertia lever member 12 can pass as shown by a chain line in FIG. 6 when the inertia lever member 12 pivots between the inoperative position and the operative position, and a pivot preventing portion 2m3 for preventing the pivotal movement of the inertia lever member 12 into the inoperative position by the contact with the pressed portion 12d as shown by a two-dot chain line in FIG. 8 when the inertia lever member 12 moves due to inertia.

Supporting groove 2d, guide hole 2f and guide groove 2k formed in the side wall 2a are not shown in FIG. 6, but are formed in the same configurations as the supporting groove 2e, the guide hole 2g and the guide groove 2m, respectively. Though the components of the guide hole 2f are not shown in FIG. 6, these are designated as a longitudinal hole portion 2f1, a vertical hole portion 2f2, a lock-pin holding portion 2f3, a guiding portion 2f4, and a rounded portion 2f5 in the following description.

The latch member 4 has an arcuate, depending joggle or scoop-shaped portion 4c which can fit in tongue window 30, as can be seen best in FIG. 10. The depending scoop portion 4c is at the front end of the latch member 4. Accordingly, the forward, tongue-engaging portion 41 of the latch member body 407 includes the depending scoop portion 4c. More particularly, the forward, tongue-engaging portion 41 has a wing-shaped, portion 41′ including the lateral tabs 4h and 4g adjacent the rearwardmost portion 42 of the latch member 4 which also has a wing-shaped portion 42′ so that wing shaped portions 42′ and 41′ are at the rear section 4070 of the latch member split body 407. An inclined portion 4c′ extends downward from wing shaped portion 41′ to the scoop portion 4c of the forward portion 41 of the latch member body 407. The inclined and scoop portions 4c′, 4c are at the front section 4070′ of the latch member body 407.

Continuing with the detail of the construction of the latch member 4, the body 407 also includes pressed portions 4d, 4e which can be pressed by an end opposite to the operational end of the operational button 6 to move the latch member 4 in a releasing direction when the tongue 3 and the buckle 1 are disengaged by the operational button 6, and a spring supporting portion 4f for supporting one end of the slider spring 9. The latch member 4 takes a non-latched position where the tongue 3 is not engaged and held by the latch member 4, and a latched position where the tongue 3 is engaged and held by the latch member 4. The latch member 4 can pivot about the tab portions 4a, 4b between the non-latched position and the latched position.

The lock pin 5 is disposed so that the lower end thereof always contacts the top surface of the latch member 4. The lock pin 5 takes the aforementioned locked position, set by the spring force of the slider spring 9, where the lock pin 5 is positioned in the longitudinal hole portions 2f1, 2g1 of the inverted T-shaped guide holes 2f, 2g to lock or keep the latched state of the latch member 4 while the latch member 4 engages the tongue 3, and the aforementioned unlocked position, set by the operating force of the operational button 6, where the lock pin 5 is positioned in the vertical hole portions 2f2, 2g2 of the inverted T-shaped guide holes 2f, 2g to release the engagement of the latch member 4 from the tongue 3, wherein the unlocked position is located on the right side of the locked position. The lock pin 5 has a section formed in a substantially rectangular shape or a substantially inverse trapezoidal shape having a shorter bottom side. During the movement of the lock pin 5, one corner 5b of the lock pin 5 always touches the guiding portions 2f4, 2g4 or the rounded portions 2f5, 2g5 of the guide holes 2f, 2g and the upper surface 5a of the lock pin 5 touches the holding portions 2f3, 2g3. The corner 5b is a rounded portion, the radius of which is set preferably as smaller as possible.

The operational button 6 has a plane portion 6a extending in the longitudinal direction and in the width direction, side walls 6b (one side wall is not shown in FIG. 2 and is formed in the same manner as the side wall 6b. For convenience of explanation, numeral 6b designates both sidewalls formed perpendicularly to the plane portion 6a and thus disposed on both side edges of the plane portion 6a, and a spring supporting portion 6c disposed at a position shifted to one side from the center along the longitudinal direction, for supporting the other end of the button spring 10. In this case, as shown in FIG. 4 and FIG. 5, the plane portion 6a and the side walls 6b of the operational button 6 form together an inverted U-shaped cross-section and extend to the right side of the shaft portions 12a, 12b of the inertia lever member 12. Disposed inside the side walls 6b of the operational button 6 are inertia lever operating portions, not shown in FIG. 2 through FIG. 5, having inclined surfaces which press the pressed portions 12c, 12d of the inertia lever member 12 in such a manner as to move the inertia lever member 12 from the operative position to the inoperative position (schematically shown in FIG. 6 as an inertia lever operating portion 6d). Also disposed inside the side walls 6b of the operational button 6 are lock pin operating portions, also not shown in FIG. 2 through FIG. 5, having vertical surfaces which press the both end portions of the lock pin 5 to move the lock pin 5 from the locked position to the unlocked position (schematically shown in FIG. 6 as a lock pin operating portion 6e).

As the operational button 6 is operated to move to the right for releasing the state in which the tongue 3 and the buckle 1 are engaged, the inertia lever operating portions 6d come in contact with the pressed portions 12c, 12d of the inertia lever member 12 to press the pressed portions 12c, 12d toward the inoperative position of the inertia lever member 12, and then, the lock pin operating portions 6e come in contact with the lock pin 5 to move the lock pin 5 toward its unlocked position. The ejector 7 has a protrusion 7c which is disposed along the longitudinal center thereof and comes in point-contact with the tongue-engaging portion 4c of the latch member 4, and a spring supporting portion 7d for supporting the other end of the ejector spring 11. The slider 8 has a spring supporting portion 8b for supporting the other end of the slider spring 9.

The inertia lever member 12 composes a shock-proof system for preventing the movements of the lock pin 5 and the operational button 6 into their release positions due to inertia while the tongue 3 and the buckle 1 are engaged. The inertia lever member 12 has levers 12e, 12f, mass bodies 12g, 12h which are structured to have center of gravity substantially perpendicular to the extension direction of the levers 12e, 12f, and a spring supporting portion 12i for supporting one end of the lever spring 14. In this case, the mass of the mass bodies 12g, 12h is designed in such a manner that the moment about the shaft portions 12a, 12b produced by the inertia force acting on the center of gravity of the mass bodies 12g, 12h due to inertia is larger than the moment around the shaft portions 12a, 12b produced by the force of the inertia lever operating portions 6d for pressing the pressed portions 12c, 12d of the inertia lever member 12 toward the inoperative position of the inertia lever member 12 due to the inertia movement of the operational button 6 in the releasing direction. The spring holder 13 has a spring supporting portion 13c for supporting the other end of the lever spring 14. Among the aforementioned components, the operational button 6, the ejector 7, the slider 8, the spring holder 13, the upper cover 15, and the lower cover 16 are made of resin and the other components are made of metal.

More generally, loading of the latch member assembly 40 occurs when a seat belt 111 is secured about a seat occupant 121 by releasably latching the seat belt tongue plate 3 in the buckle 1 (e.g., see FIG. 19). This creates tension in the seat belt 111, which translates into a force on the tongue plate 3 that pulls the latch member tab portions 4g, 4h of wing portion 41′ forwardly toward adjacent forward stop wall portions 2d′, 2e′ of the frame openings 2d, 2e (i.e., on the side of the opening nearest openings 2k, 2m) of buckle frame 2 (e.g., refer to FIG. 3 for cited feature locations). Referencing FIG. 7, preferably the relative sizing of the latch member 4 and associated frame openings 2d, 2e and 2s, 2t of base frame 2, and specifically the longitudinal spacing between tabs of the front and rear portions 41, 42 and the longitudinal spacing of the forward wall portions of the respective frame openings, respectively, is such that when the latch member 4 is loaded, then the rear portion tabs 4a, 4b of rear portion 42 will engage the adjacent forward wall portions 2s′, 2t′ of openings 2s, 2t (which are defined by the rearward facing side of stops 2v, 2w) when there is still spacing between the forward tabs 4g, 4h of forward portion 41 and the forward wall portions 2d′, 2e′ of openings 2d, 2e adjacent thereto. In this regard, with the tongue plate 3 latched in the buckle 1, the normal spacing between the rear set of tabs 4a, 4b and adjacent forward wall portions 2s′, 2t′ of openings 2s, 2t is less than the spacing between the forward set of tabs 4g, 4h and adjacent forward wall portions 2d′, 2e′ of openings 2d, 2e. This spacing allows the latch member 4 to continue to deform when loaded after the rear tabs 4a, 4b are engaged with the forward wall portions 2s′, 2t′ of openings 2s, 2t adjacent thereto (i.e., the rearward side of stops 2v, 2w). Thus, the spacing between the forward tabs 4g, 4h and the stop or forward wall portions 2d′, 2e′ of openings 2d, 2e adjacent thereto may be taken up after the rear portion 42 has engaged against the adjacent stop wall portions 2s′, 2t′ of openings 2s, 2t with continued loading on the latch member 4.

As indicated, there are current latch members having a split body construction but with the forward and rear portions being integrally interconnected by a longitudinally extending portion that is narrower than the wider, laterally extending forward and rear latch portions so that the latch member has a one-piece, generally H-shaped body. More specifically, the latch member has the H-shape provided at a rear section thereof. The latch member has a depending front portion or section from the H-shaped section of the body which engages in the window of the tongue plate for latching it in the buckle.

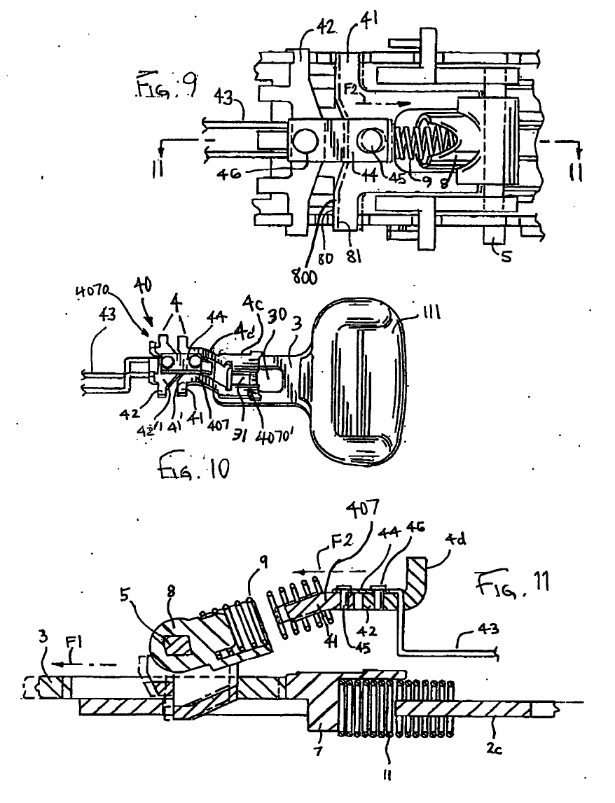

In this respect, and referring to FIGS. 12-16, in another embodiment an alternative buckle integrated, seat belt tension sensor configuration is provided which can be effectively utilized with a latch member 410 having a unitary split-body 410a that includes tension responsive structure in the form of a generally H-shaped body portion 407′. This configuration avoids changing the standard buckle configuration but for the manner of integration of the above-described sensor 400 therewith. In this form, a latch member assembly 405 is provided in which a strain sensor 44 is mounted to extend, preferably without fixation thereto, along a relatively narrow bridging portion 409 of the latch member body 407′ and is fixed to the adjacent forward and rear wide or wing portions 411, 412 thereof, respectively. By comparison, the above-described latch member 4 having the completely split-body construction so that there are distinct forward and rear portions or members described earlier is obtained by substantially eliminating the narrow portion 409 of these current one-piece latch members 410. Nevertheless, the latch member 410 also is provided with a substantially planar or flat sensor mounting portion including adjacent openings or gaps on either side of the narrow portion 409 between the wing portions 411 and 412, and thus the gaps are also adjacent to the sensor 44 extending therealong. By having the gaps alongside the bridge portion 409, the sensor mounting portion will be more responsive to tension applied thereto.

The strain sensor 44 has first and second holes 401 and 402 at opposite end portions 401′, 402′ thereof, respectively, aligned with first and second apertures 403′ and 404′ provided respectively in the forward and rear wide portions 411, 412, and respective first and second attachment means 45 and 46 interconnectedly extend therethrough for connecting these parts into unitary latching and sensing assembly 405. The attachment means 45 and 46 used for this embodiment may include the previously described means used for latch member assembly 40.

Referring to latch member assembly 405, it is anticipated that by placing the strain sensor 44 on a section of the latch member body portion 407′ that will undergo greater longitudinal deformation when the seat belt is loaded, operation of the sensor 44 will be optimized. In other words, the bridge portion 409 is identified herein as a favorable location along which the sensor 44 is to extend to allow the sensor 44 to generate a larger output signal for increased measurement resolution. Since the loaded strain sensor 44 extends primarily along the narrow portion 409 of the latch body portion 407′ and is fixed to wide portions 411, 412 of the body portion 407′ integrally located at either end of the narrow portion 409, the loaded latch member 410 will deform along the same portion of the latch member that is most likely to deform with high tension loads, i.e. the narrow portion 409.

In this form with the latch member 410 having a unitary split body 410a, the wide forward and rear wing portions 411, 412 each include laterally extending pairings of tab portions 4g, 4h and 4a, 4b, respectively, that fit in respective openings and 2d, 2e and 2s, 2t, respectively, of the buckle frame 2, similar to the arrangement described above relative to latch member assembly 40. Similar thereto, the frame openings have forward or stop wall portions that limit forward shifting of the respective latch member front and rear portions 411, 412 when the latch member 410 of latch member assembly 405 is loaded. That is, it is loaded when the seat belt 111 is secured about a seat occupant 121 by releasably latching the seat belt tongue plate 3 in the buckle 1 (e.g., see FIG. 19) . The tension this generates in the seat belt 111 is transferred to a force on the tongue plate 3 that pulls the latch member tab portions 4h, 4g of forward wide portion 411 forwardly toward the adjacent forward stop wall portions 2e′, 2d′ of the frame openings 2e, 2d of buckle frame 2, after rear tabs 4a, 4b of rear wide portion 412 have already engaged with the forward wall portions 2s′, 2t′ of openings 2s, 2t.

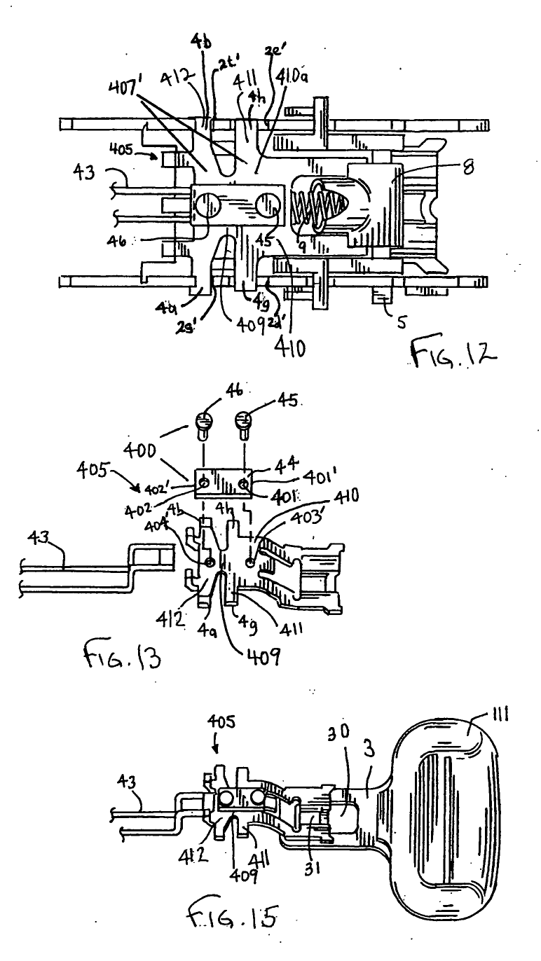

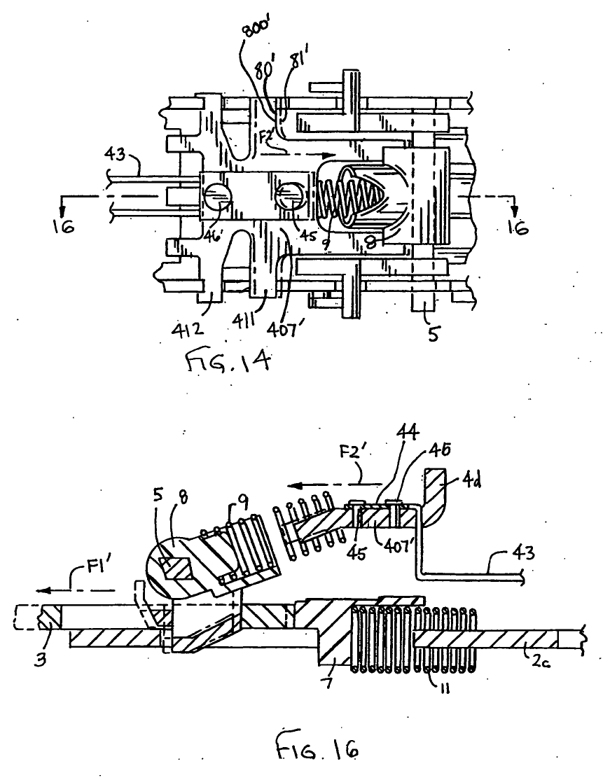

Referring to FIGS. 14 and 16, when a tension force, indicated by force arrow F1′, is applied to a seat belt 111, and, thus also upon the tongue 3 connected thereto, the tongue 3 pulls on the latch member 410 of the latch member assembly 405, such as indicated by a corresponding elongation force indicated by force arrow F2′. After engagement of the rear tabs 4a and 4b with the corresponding stop wall portions 2s′ and 2t′, a slight displacement of the front portion 411 can occur due to a sufficiently high belt tension, such as indicated by the movement of leading edge 800′ of wing portion 411 from position 80′ to a different slightly displaced leading edge position at 81′ (FIG. 14). The strain gauge 44 can readily sense the tension force F2′ induced between the two wide latch member portions 411 and 412 as, in this instance, there is an easily perceptible relative shifting between these two portions of the latch member 40 in the longitudinal direction. With this latch member assembly 405, the strain gauge 44 will still sense the strain within the latch member 410 due to seat belt tension (FIG. 15). The strain gauge 44 thus is a sensor that detects strains in the material of the latch member 410.

Additional descriptions explaining and illustrating the basic action of the buckle for engaging the tongue and the action for preventing the inertia release while the buckle and the tongue are engaged are set forth in U.S. Pat. No. 6,370,742 B1, which descriptions are incorporated herein by reference. Also, though there is no illustration in any of the drawings, a known buckle pretensioner may be connected to the base 2 of the buckle 1. The buckle pretensioner is actuated in case of emergency, such as a vehicle collision, to rapidly pull the base 2 to the right in the drawings, whereby the seat belt can quickly restrain a vehicle occupant. Though the buckle of this illustration may be connected to the buckle pretensioner, it should be understood that the present invention can be applied to a buckle of a seat belt device without a buckle pretensioner.

Referring to FIG. 17, another alternative buckle integrated, seat belt tension sensor configuration is provided. A latch member 4100 has a body 4100a that is provided with tension responsive structure similar to the previously described latch member assemblies 40 and 405. The tension responsive structure is in the form of a depending arcuate portion 4071 that forms an opening or gap recess 4074 in the latch member body. Accordingly, the latch member 4100 is provided with a sensor mounting body portion 4070 with the sensor 44, preferably strain gauge 44, spanning the gap 4074 and fixed to the body portion 4070 on either side 4072 and 4073 of the gap 4074. Similar to completely split latch member body 407 that defines a gap across which the sensor 44 extends, the latch member body 4100a has sensor mounting portion 4070 including recessed gap 4074 that underlies the sensor 44 so that the sensor mounting portion 4070 is more responsive to tension applied thereto. The bead portion 4071 is adapted to deform or flex in response to strain induced in the body portion 4070 due to seat belt tension. The strain will tend to straighten the bend portion 4070 to provide a tensile load across the recess 4074 to sensor 44. This straightening of the bead portion 4070 will advantageously induce relatively large strains in the strain gauge 44 for providing it with improved seat belt tension sensing capabilities.

Referring to FIG. 18, a seat belt assembly 110 including the buckle 1 in accordance with an embodiment of the present invention is shown, which includes a seat belt 111 that can have a common three-point anchor arrangement, for example. The buckle 1 is connected to an upstanding, buckle support device 113 at an inboard side of the seat 125 and which can be anchored at its opposite, lower end to the vehicle in a conventional manner (not shown). The buckle 1 engages a tongue 3 slidably mounted on the belt 111. With the tongue 3 releasably latched in the buckle 1, a shoulder belt segment 115 of the seat belt 111 is defined to extend from the tongue/buckle connection up along the seat occupant's torso, through a guide loop and back down to a retractor (not shown) with both the guide loop and retractor anchored to the vehicle in a conventional manner. Buckle 1 includes strain sensor 44, which is incorporated into the latch member assembly thereof as described earlier herein. Strain sensor 44 communicates with controller 117 via communication lines 119, which are connected at the strain sensor 44 via the previously described wire harness 43.

Referring to FIG. 19, an occupant restraint system 120 is shown that incorporates a seat belt assembly of FIG. 18 including a buckle 1 in accordance with an embodiment of the present invention. A passenger 121, such as a small child, is sitting on a booster seat member 123, both of which are resting on vehicle chair 125. The passenger 121 is restrained on chair 125 by seat belt 111 having its belt segments 113 and 115 releasably fastened together at buckle 1. In the illustration shown, a passenger protection device 127 includes an inflatable restraint such as an air bag 128. As known, prior to deployment, an inflatable air bag is stored in a folded condition in a vehicle dashboard or instrument panel 129. It is to be appreciated by a person of ordinary skill in the art that the passenger protection device 127 may be another type of actuatable protection device (e.g., a driver's side restraint module, not shown) and may be located elsewhere within the vehicle (e.g., on the steering wheel, in the vehicle side door, knee bolsters, etc.).

Deployment of the air bag 128 is controlled by controller 117. The controller 117 may receive input from any number of sources, but for purposes herein includes at least sensory inputs acquired from collision sensor 131 via communication line 132, seat weight sensor 133 via communication line 134, and strain sensor 44 incorporated in buckle 1 via communication line 119 as previously described. Using the sensory input, controller 117 makes determinations for controlling the deployment of the air bag 128. These determinations are provided to the restraint device in the form of control signals to control the deployment of the air bag 128. The system 120 also may include a standard buckle fastening sensor that may be another function of the sensor 44 which is operable to cause a warning light to be displayed and/or chimes to ring, etc., in the event the seat belt is unfastened when the seat is occupied. The controller 117 has any suitable construction. For instance, the controller 117 may be part of and/or include a computer, microcomputer, microprocessor, plurality of discrete components and/or integrated circuits.

An example of a source of sensory input is sensor 131. Sensor 131 is referred to as a collision or crash sensor, and it senses a vehicle crash condition for which the occupant 121 may need to be protected and provides a signal to the controller 117 indicative of the sensed vehicle condition. In an embodiment of such an example, the collision sensor 131 may be an accelerometer and the signal is an electrical signal indicative of the sensed crash acceleration. It is to be appreciated that the system 120 could have a plurality of such vehicle sensors 131, which provide a plurality of signals to the controller 117 indicative of sensed vehicle conditions. Other sensed vehicle conditions may include, for example, vehicle speed, closing speed with an object, closing angle and vehicle rollover.

The sensor 133 provides a signal to the controller 117 indicative of the total downward force sensed by sensor 133. The sensed weight of the seat occupant 121 can be affected when the seat belt 111 is used by the occupant 121. For instance, when the seat belt 111 is used to retain a child seat 123 on the vehicle seat 125, it is not uncommon for the seat belt 111 to be cinched very tightly across the child seat 123 so that movement of the child seat 123 on the vehicle seat 125 is limited. In this situation, there may be a relatively large amount of tension in the seat belt 111. This additionally exerted force can affect and distort the sensed or perceived weight of the occupant 125 by seat sensor 133.

The restraint system 120 of the present invention can be used to compensate or adjust the sensed weight of the occupant 121 when the occupant 121 is restrained by a seat belt 111. In embodiments of the present invention, tension in the seat belt 111 is sensed via a strain sensor 44 incorporated into buckle as described herein. The controller 117 is operable to correlate the strain sensed by sensor 44 at the buckle to tension in the seat belt 111.

In one preferred embodiment, the strain sensor 44 is a resistive strain gauge. A preferred strain gauge measures deformation of the body of the latch member due to strain applied thereto by the seat belt tension. As indicated, other types of strain sensors also may be used, such as piezoresistors sensors, Hall effect sensors, and so forth. Resistive strain gauges function by exhibiting changes in resistance proportional to strain (e.g., elongation force) which causes dimensional changes of the resistor. For example, the strain sensor 44 may include a substrate on which are positioned strain gauge resistors on one face (not shown), and which is anchored in engagement with the latch member 4 at the opposite face of the substrate. The strain sensor 44 is operable to output an electrical signal indicative of how much it stretches. Because the strain sensor 44 is affixed to the surface of the latch member 4 of the latch member assembly, the strain sensor 44 perceives strain pulling force applied to the latch member 4. The latch member 4 stretches a slight amount when tension is applied to the latch member 4. As indicated, the strain sensor 44 senses the tension induced between the two latch member plate portions 41 and 42. The strain sensor 44 will still sense the strain within the latch member 4 when the belt tension increases on the respective portion of the latch member 41 or 42 that engages in the window opening 30 or 31 of the respective tongue plate 3 or latch member 4 (see FIG. 10). The degree to which the latch member 4 stretches is proportional to the applied tension. Therefore, because the strain sensor 44 is affixed to the surface of the latch member 4, the amount of perceived strain is proportional to the tension on the latch member 4. Accordingly, the strain sensor 44 outputs an electrical signal to the controller 117 indicative of the tension on the latch member 4. Because the latch member 4 is part of the buckle 1 of the seat belt system 110, which is engaged by the tongue 3 when the seat belt 111 is securely latched across the occupant (and any child seat), the change in resistance developed by the strain gauge circuitry is proportional in magnitude to the tension in the seat belt 111. Therefore, the strain sensor 44 can output a signal to controller 117 which is functionally related to the tension in the seat belt 111. The strain sensor 44 alternatively can be mounted on above-described alternative latch configuration with a unitary split body latch member 410, and operated in a similar manner.

The correlation between changes in resistance sensed at the strain sensor 44 and tension in seat belt 111 can be determined in a manner that is conventionally understood and applied. A non-limiting example of a general algorithm and related signal processing and/or conditioning circuitry that may be adapted to support a sensor/latch member assembly as described herein for detecting the presence of a child seat or underweight passenger is described in commonly assigned U.S. Pat. No. 6,382,667 B1, which descriptions are incorporated herein by reference for all purposes. It also will be appreciated that signal processing and/or conditioning microelectronics optionally may incorporated in the buckle 1, particularly in view of the fact that the sensor/latch assemblies described herein require very little in the way of significant changes, if any, to the size or operation of applicant's assignee's current buckle beyond inclusion of the strain sensor at a predetermined location on the latch member.

In one implementation, the controller 117 is operable to subtract a value functionally related to the sensed strain (which corresponds to the belt tension) from a value functionally related to the sensed downward force to determine the true weight of the passenger. In this manner, system 120 can calculate the amount by which the sensed weight of the occupant should be reduced to account for the effect of the downward force applied to the occupant 121 by seat belt 111. In particular, in the case of a child seat 123 being used, the sensed weight at chair 125 is reduced to account for the effect of the downward force applied to the child seat 123 by seat belt 111. The controller 117 can thereafter control air bag deployment accordingly, such as suppressing deployment entirely.

The strain sensor 44 also may be adapted to operate in a wireless mode. In that instance, it would not be necessary to include the wire harness 43. For example, the strain sensor could incorporate a microstructured RF frequency communication device in a common semiconductor chip or circuit board that also embodies strain-sensing structures. The implementation of microstrain sensing structures in a semiconductor substrate is generally known. If used as a wireless device, the strain sensor may include a battery power source (e.g., a lithium battery), or, alternatively, it may operate as a passive sensing node which can be interrogated by a controller/processor via signaling transmitted between coil antennas at the controller and at the remote sensing node, prompting the sensor to emit signals in real time back to the controller/processor which provide information on a sensed state (viz., strain) at the sensing device. Persons of ordinary skill in the sensor arts will be generally familiar with such types of sensors, albeit not as adapted for use on a latch member of a belt buckle as presented herein. Whether used in hard-wired or wireless communication modes, the strain sensor 44 generally may send signals in analog form to an A/D converter in communication with or forming part of the controller, so that the signals can be processed in a digital format by the controller.

As can be appreciated from the above, the buckle and belt tension sensor arrangements provided herein optimize operation of the sensor without requiring significant modifications to the buckle and its operating mechanisms, in particular with respect to the configuration and/or size thereof. The preferred mounting of the sensor to a latch member having a split-body construction, such as illustrated herein, to extend between split portions thereof enhances the capability of the sensor to detect tension in the seat belt. As indicated, the split latch member body may be either of a single-piece or multiple-piece construction, although the multi-piece latch member is preferred for enhancing the response of the sensor to tension forces in the seat belt. In either instance, however, the split-body, latch member construction does not affect size or operation of the buckle mechanism in any significant way. On the other hand, as mentioned, the split body of the latch member does enhance the capacity for the sensor, such as a strain gauge, to effectively detect tension in the seat belt with the tongue plate releasably latched in the buckle. By having a split-body construction, the latch member body can transmit a greater amount of strain under loading to the sensor so that the sensitivity of the strain gauge need not be as great as otherwise might be required with latch members lacking a split-body construction, as described herein. The split body construction of the latch member also allows the strain gauge to generate an output signal of a greater magnitude to improve on its measurement resolution since typically reliable strain measurements can be difficult due to the low level of output from these types of sensors. In this regard, the preferred form of the invention includes a multi-piece split body latch member body and a strain gauge sensor that interconnects the distinct latch body members which does not require changes to any of the other buckle components or otherwise affect operation of the buckle since the strain gauge sensor has a thin or low profile body and generally takes up the space between the latch body members formerly occupied by the narrow portion of the one-piece latch member body, and interconnects the body members.

This facile solution for incorporating a belt tension sensor in a buckle also eliminates the needs for extra parts and associated assembly complications that otherwise could be required to successfully integrate an operable strain gauge into a seat belt system.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A buckle for receiving a tongue plate on a seat belt, the buckle comprising:
a frame;
a latch mechanism mounted to the frame for maintaining the tongue plate in the buckle in a releasably latched condition;
a latch member of the latch mechanism having a body including tension responsive structure; and
a sensor mounted to the body to detect tension in the seat belt with the tongue plate in the latched condition with the tension responsive structure inducing large strains in the sensor for ease in detecting seat belt tension therewith.

2. The buckle of claim 1 wherein the latch member body has a sensor mounting portion, and the tension responsive structure comprises at least one opening in the sensor mounting portion.

3. The buckle of claim 2 wherein the opening comprises a gap between rear and forward portions of the latch member body.

4. The buckle of claim 3 wherein the sensor is mounted to the latch member to span the gap.

5. The buckle of claim 4 wherein the rear and forward portions are distinct members spaced by the gap and interconnected by the sensor.

6. The buckle of claim 4 wherein the rear and forward portions are interconnected by an integral bend portion forming the gap as a recess between the rear and forward portions.

7. The buckle of claim 3 wherein the latch member body has a narrow portion extending between the rear and forward portions with the sensor mounted to the body to extend along the narrow portion, and the gap comprises gaps on either side of the narrow portion.

8. The buckle of claim 1 wherein the latch member body has a split construction including a forward tongue engaging portion that holds the tongue plate in the buckle and another body portion split therefrom.

9. The buckle of claim 8 wherein the split portions of the latch member each include lateral tabs, and the frame has slots in which the tabs are received for guiding movement of the latch member between a locked position with the tongue engaging portion holding the tongue plate in the buckle, and an unlocked position with the tongue engaging portion releasing the tongue plate for being inserted or removed from the buckle.

10. The buckle of claim 9 wherein the frame includes end wall portions of the slots for limiting shifting of the tabs in the slots as the tongue plate is loaded by the tension in the seat belt.

11. The buckle of claim 8 wherein the split latch member includes split lateral portions on either side of the latch member so that there are gaps between the lateral portions, and the sensor extends intermediate the gaps, along the body of the latch member.

12. A buckle for receiving a tongue plate on a seat belt, the buckle comprising:
a frame;
a latch member associated with the frame and having a locked position with the latch member releasably holding the tongue plate in the buckle and a release position with the latch member allowing the tongue plate to be inserted into and removed from the buckle;
a body of the latch member having a split construction including forward and rear portions of the body with the split-body construction providing for relative shifting between the forward and rear body portions or for deformation of the body with the latch member in the locked position and tension in the seat belt; and
a sensor mounted to extend between the forward and rear portions of the latch member body for detecting tension in the seat belt with the split-body construction providing the sensor enhanced response to seat belt tension forces.

13. The buckle of claim 12 wherein the forward and rear portions of the latch member body are distinct members that can shift relative to each other and are interconnected by the sensor.

14. The buckle of claim 12 wherein the frame has side walls, the forward and rearward body portions have laterally extending tabs, the side walls have openings including stop wall portions with the tabs extending into the openings, and longitudinal spacing of the tabs of the latch member body portions relative to the stop wall portions of the respective frame side wall openings allowing for relative shifting between the forward and rearward body portions or deformation of the body between the body portions.

15. The buckle of claim 12 wherein the latch member includes a rear section having the forward and rear body portions, and a forward section including a scoop portion that depends from the forward portion of the latch member rear section.

16. The buckle of claim 12 wherein the sensor comprises a strain gauge.

17. The buckle of claim 12 wherein the latch member has unitary body with a section that has an H-shaped configuration including the forward and rear portions interconnected by a narrow portion, and the sensor is fixed to the forward and rear portions and extends along the narrow portion.

18. The buckle of claim 12 including fasteners that fix the sensor to the forward and rear portions of the latch member body.

19. A buckle and tongue assembly for a seat belt, the buckle and tongue assembly comprising:
a buckle having a latch mechanism;
a tongue plate for being inserted into the buckle to a predetermined locked position at which the latch mechanism is operable to releasably hold the tongue plate in the buckle;
a latch assembly of the latch mechanism including distinct forward and rear members, and a tongue engaging portion that engages the tongue in the predetermined locked position to hold the tongue in the buckle; and
a sensor of the latch assembly that interconnects the latch assembly forward and rear members.

20. The buckle and tongue assembly of claim 19 wherein the sensor comprises a tension sensor.

21. The buckle and tongue assembly of claim 20 wherein the tension sensor is selected from the group consisting of a strain gauge, a piezoelectric sensor, and a Hall effect sensor.

22. The buckle and tongue assembly of claim 19 wherein the latch assembly has front and rear sections with the front section including the tongue engaging portion and rear section including the forward and rear members and the sensor.

23. A buckle comprising:
a base having side walls;
a latch member assembly comprising a latch member supported by the side walls to pivot between an unlatched position and a latched position so that when a tongue is inserted to a predetermined position, the latch member pivots to the latched position to engage the tongue, wherein said latch member comprises a discrete first plate portion, a discrete second plate portion, and a connection integrally attaching said first and second plate portions wherein said connection includes a strain sensor operable to output signals corresponding to magnitude of strain sensed in said attached first and second plate portions, and wherein the first plate portion is operable to engage the tongue when the latch member pivots to the latched position and the second plate portion is operable to move the latch member in a releasing direction when the tongue is disengaged;
an operational member for releasing the engagement between the tongue and the first plate portion of the latch member; and
a lock member attached to the base to be movable between an unlocked position and a locked position, said lock member being set in the locked position to hold the latch member in the latched position when the tongue is engaged with the latch member, and being moved by the operational member to the unlocked position to allow the engagement between the tongue and the latch member to be released.

24. A buckle according to claim 23, wherein said strain sensor comprises a resistive strain sensor adapted to communicate with a controller via conductive wiring.

25. A buckle according to claim 24, wherein said conductive wiring comprises a wire harness having a contact portion operably attached between the strain sensor and the attached first and second plate portions of the latch member.

26. A buckle according to claim 23, wherein said strain sensor comprises first and second holes at opposite end portions thereof aligned with first and second apertures provided respectively in said first and second plate portions, and respective first and second attachment means interconnectedly extending therethrough.

27. A buckle according to claim 26, wherein said first and second attachment means comprise rivets.
